(19) United States
(12) Patent Application Publication
(10) Pub. No.: US 2026/0117934 A1
(43) Pub. Date: Apr. 30, 2026

(54) HYDROGEN CARRIER STORAGE CONTAINER AND BYPRODUCT STORAGE CONTAINER

(71) Applicant: CANON KABUSHIKI KAISHA, Tokyo (JP)

(72) Inventors: KENJI UTSUNOMIYA, Tokyo (JP); SHOKO FUJIWARA, Ibaraki (JP); KEIJI KARUBE, Ibaraki (JP); AKIKO TOMINAGA, Kanagawa (JP); SHUNSUKE TSUDA, Tokyo (JP); TSUYOSHI KUROKI, Kanagawa (JP)

(21) Appl. No.: 19/420,971

(22) Filed: Dec. 16, 2025

Related U.S. Application Data
(63) Continuation of application No. PCT/JP2024/018955, filed on May 23, 2024.

(30) Foreign Application Priority Data
Jun. 27, 2023 (JP) 2023-104629

(51) Int. Cl. F17C 13/08; F17C 13/04

(52) U.S. Cl. CPC F17C 13/08; F17C 13/04; F17C 2201/0157; F17C 2205/013; F17C 2205/0169; F17C 2205/018; F17C 2205/0332; F17C 2221/012; F17C 2270/0184

(57) ABSTRACT

A pair of flat portions is provided on both sides of an outer wall surface of a storage container, respectively, in at least one of an up-down direction, a left-right direction, and a front-rear direction in an installed state of the storage container. A recess is formed at a portion of at least one of the pair of flat portions, and is formed so as to be recessed inward with respect to another portion of the flat portion and to at least partially communicate with the outside of the flat portion in a direction along the flat portion. A relief valve is provided in the recess and is automatically opened in a case where a pressure inside a storage portion for storing a hydrogen carrier exceeds a predetermined value to release gas inside the storage portion to the outside.

### CROSS-REFERENCE TO RELATED APPLICATIONS

This application is a Continuation of International Patent Application No. PCT/JP2024/018955, filed May 23, 2024, which claims the benefit of Japanese Patent Application No. 2023-104629, filed Jun. 27, 2023, both of which are hereby incorporated by reference herein in their entirety.

### BACKGROUND

### Field of the Technology

The present disclosure relates to a hydrogen carrier storage container and a byproduct storage container for storing a hydrogen carrier and a byproduct.

### Description of the Related Art

As a storage container for storing gas, a configuration in which an upper surface and a lower surface are flat such that the storage containers can be vertically stacked has been proposed (WO 2019/026872 A).

### SUMMARY

Hitherto, an apparatus for generating hydrogen by reacting a hydrogen carrier with a water-containing liquid has been known. Further, it has also been conventionally known that a byproduct is generated together with hydrogen at this time. In a case where such a hydrogen carrier and a byproduct are stored in a storage container, gas such as hydrogen may be generated in the storage container depending on a storage environment. In this case, since there is a possibility that a pressure in the storage container increases and the storage container ruptures, it is conceivable to provide a relief valve that releases the gas inside the storage container to the outside.

However, in a case where the storage containers are stored so as to be stacked in an up-down direction or arranged closely in a left-right direction or a front-rear direction, the relief valve is blocked, as a result of which the gas is not sufficiently discharged from the inside of the storage container, and the pressure in the storage container may increase.

The present disclosure is to provide a configuration capable of suppressing an increase in pressure in a storage container even in a case where the storage containers for storing a hydrogen carrier and a byproduct are stored so as to be stacked in an up-down direction or arranged closely in a left-right direction or a front-rear direction.

According to a first aspect of the present disclosure, a hydrogen carrier storage container configured to store a hydrogen carrier, the hydrogen carrier storage container includes a storage portion storing the hydrogen carrier, a pair of flat portions provided on both sides of an outer wall surface of the storage container, respectively, in at least one of an up-down direction, a left-right direction, and a front-rear direction in an installed state of the storage container, a recess formed at a portion of at least one of the pair of flat portions and formed so as to be recessed inward with respect to the other portion of the flat portion and to at least partially communicate with an outside of the flat portion in a direction along the flat portion, and, a relief valve provided in the recess and automatically opened in a case where a pressure inside the storage portion exceeds a predetermined value to release gas inside the storage portion to an outside.

According to a second aspect of the present disclosure, a byproduct storage container configured to store a byproduct generated together with hydrogen in a case where a hydrogen carrier reacts with a water-containing liquid, the byproduct storage container includes a storage portion storing the byproduct, a pair of flat portions provided on both sides of an outer wall surface of the storage container, respectively, in at least one of an up-down direction, a left-right direction, and a front-rear direction in an installed state of the storage container, a recess formed at a portion of at least one of the pair of flat portions and formed so as to be recessed inward with respect to the other portion of the flat portion and to at least partially communicate with an outside of the flat portion in a direction along the flat portion, and, a relief valve provided in the recess and automatically opened in a case where a pressure inside the storage portion exceeds a predetermined value to release gas inside the storage portion to an outside.

Features of the present disclosure will become apparent from the following description of embodiments with reference to the attached drawings.

### BRIEF DESCRIPTION OF THE DRAWING

FIG. 1 is a schematic configuration diagram of a hydrogen generation system according to a first embodiment.

FIG. 2 is a schematic cross-sectional view of a storage container according to the first embodiment.

FIG. 3 is a schematic perspective view of the storage container according to the first embodiment.

FIG. 4 is a schematic cross-sectional view illustrating an example of a storage state of the storage container according to the first embodiment.

FIG. 5 is a schematic perspective view illustrating an example of the storage state of the storage container according to the first embodiment.

FIG. 6A is a schematic cross-sectional view illustrating a state in which a storage container according to another example of the first embodiment is fitted.

FIG. 6B is a schematic cross-sectional view illustrating a state in which the storage container according to another example of the first embodiment has been fitted.

FIG. 7 is a schematic configuration diagram of a hydrogen generation system according to a second embodiment.

FIG. 8 is a schematic cross-sectional view of a storage container according to the second embodiment.

### DESCRIPTION OF THE EMBODIMENTS

### First Embodiment

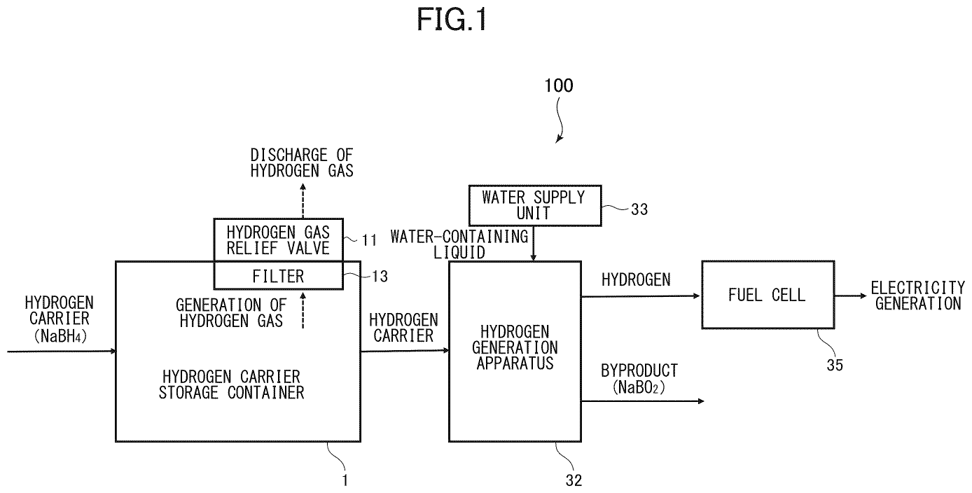

A first embodiment will be described with reference to FIGS. 1 to 5. First, hydrogen has attracted attention as an energy source replacing fossil fuels. This is because hydrogen does not generate carbon dioxide or the like, which is a kind of greenhouse gas leading to global warming, at the time of combustion, unlike fossil fuels. A fuel cell vehicle is one of systems that have been put into practical use as a system using hydrogen as an energy source. The fuel cell vehicle is an automobile that generates electricity using hydrogen as a raw material and travels by operating an electric motor with the generated electricity. In many fuel cell vehicles, hydrogen serving as an energy source is stored in a hydrogen tank, and hydrogen from the hydrogen tank is put into a fuel cell to generate electricity. The hydrogen tank compresses and stores hydrogen at a high pressure, for example, 70 MPa (700 times the atmospheric pressure).

A problem of hydrogen serving as an energy source is that an energy density is low. A volumetric energy density of hydrogen is about 1/3000 of that of gasoline, and even if a hydrogen tank of 70 MPa is used, only about ⅕ of energy of gasoline can be extracted from the same volume. Therefore, in general, the fuel cell vehicle using the hydrogen tank is required to refuel more frequently than an automobile using gasoline.

For this reason, various substances have been studied as substances (that is, hydrogen carriers) capable of carrying hydrogen at a higher energy density than that of the hydrogen tank. For example, ammonia, methylcyclohexane, and borohydrides such as sodium borohydride are known as the hydrogen carriers, and the hydrogen carrier is transported instead of transporting hydrogen itself, and hydrogen is extracted from the hydrogen carrier at the time of use.

### [Hydrogen Carrier]

Among the hydrogen carriers, metal hydrides such as sodium borohydride, from which hydrogen can be easily extracted by applying water, are widely known. As a method for obtaining hydrogen by hydrolyzing sodium borohydride, a method in which sodium borohydride is dissolved in water and used as an aqueous solution has been known. However, in the method, theoretically, a larger amount of water than a required amount indicated by a reaction formula is required, and there is a problem that a substantial volumetric energy density decreases. Therefore, in the present embodiment, as described below, a water-containing liquid is applied to the hydrogen carrier in the hydrogen generation apparatus (specifically, a water-containing liquid is applied to the hydrogen carrier) to generate hydrogen.

Examples of the hydrogen carrier that generates hydrogen by being applied with the water-containing liquid include the following. For example, one or a mixture of two or more of solid metal hydrides such as sodium borohydride, potassium borohydride, lithium borohydride, zinc borohydride, lithium aluminum hydride, sodium aluminum hydride, magnesium aluminum hydride, calcium aluminum hydride, magnesium hydride, lithium hydride, sodium hydride, and calcium hydride, and metallic powders such as aluminum, zinc, calcium, and magnesium can be used. Organic hydrides such as methylcyclohexane, cyclohexane, and decalin can also be used. Additives such as a reaction accelerator and a desiccant may be used together with the hydrogen carrier.

The hydrogen carrier of the present embodiment may be a solid or a liquid, and is not particularly limited. However, the hydrogen carrier is preferably a solid. As the solid hydrogen carrier, a powdered or granular solid is desirable, but a solid in the form of a sheet, a pellet, or a paste may also be used. As the powdered solid, a powdered solid having a particle diameter of about 10 μm or more and 10 mm or less can be used, a powdered solid having a particle diameter of about 10 μm or more and 3 mm or less is preferable, and a powdered solid having a particle diameter of about 10 μm or more and 100 μm or less is more preferable. In addition, in a case where the solid in the form of a sheet or a pellet is used, it is preferable to increase a surface area by roughening the surface and performing a porosification treatment or the like to increase a contact area with the water-containing liquid from the viewpoint of enhancing reactivity with the water-containing liquid.

The hydrogen carrier of the present embodiment is a hydrogen carrier that generates a byproduct (reaction product) other than hydrogen, such as a liquid byproduct, a gel byproduct, or a solid byproduct, after generating hydrogen by a chemical reaction.

In the present embodiment, powdered sodium borohydride having an average particle diameter of 50 μm was used as the solid hydrogen carrier. The powdered sodium borohydride reacts with water to generate hydrogen. The reacted sodium borohydride is changed into sodium metaborate as the byproduct. Water that was not used in the reaction remains. The reaction is represented by the following chemical formula.

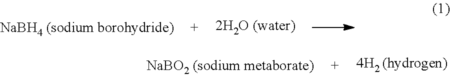

It is known that the reaction (Chemical Formula (1)) is promoted by a Raney catalyst formed of a metal such as nickel, cobalt, or copper, or an acidic solution such as citric acid or acetic acid. In addition, in the present embodiment, in a case where a larger amount of water than in Formula (1) is supplied in order to efficiently conduct a hydrolysis reaction throughout the entire hydrogen carrier, the byproduct is a liquid sodium metaborate solution or a gel sodium borate hydrate.

### [Water-Containing Liquid]

The “water-containing liquid” in the present embodiment only needs to be a liquid that reacts with the hydrogen carrier when applied with liquid to generate hydrogen, and is not particularly limited. That is, the water-containing liquid may be water alone. Two or more types of water-containing liquids may be prepared. A hydrogen generation rate can be adjusted by preparing two or more types of water-containing liquids.

The water-containing liquid can contain a water-soluble organic solvent. Examples of the water-soluble organic solvent include alcohols, polyalkylene glycols, glycol ethers, nitrogen-containing compounds, and sulfur-containing compounds. A mixture of two or more selected therefrom may be used. As the water-containing liquid contains the water-soluble organic solvent, the reaction with the hydrogen carrier can be optimized by adjusting a surface tension and adjusting a boiling point and a melting point of the water-containing liquid.

A surfactant can be added to the water-containing liquid. By using the surfactant, the surface tension of the water-containing liquid can be reduced, a contact area with the hydrogen carrier can be increased, so that an efficient reaction can be performed.

The water-containing liquid can contain a water-soluble acidic substance. The acidic substance acts as a positive catalyst in the reaction between the water-containing liquid and the hydrogen carrier. The hydrogen generation rate can be adjusted by adjusting an amount of the liquid containing the acidic substance. In particular, the hydrogen generation rate can be increased by setting the pH obtained by the water-containing liquid and the hydrogen carrier to less than 9.0. Examples of the acidic substance include, but are not limited to, various acids such as hydrochloric acid, sulfuric acid, nitric acid, boric acid, and organic acid.

The water-containing liquid can contain a water-soluble basic substance. The basic substance acts as a negative catalyst in the reaction between the water-containing liquid and the hydrogen carrier. The hydrogen generation rate can be adjusted by adjusting an amount of the liquid containing the basic substance. In particular, the hydrogen generation rate can be decreased by setting the pH obtained by the water-containing liquid and the hydrogen carrier to 9.0 or more. Examples of the basic substance include, but are not limited to, various bases such as sodium hydroxide, potassium hydroxide, and aqueous ammonia.

The water-containing liquid can contain a buffer solution. The buffer solution functions to suppress a pH change in the reaction between the water-containing liquid and the hydrogen carrier. The hydrogen generation rate can be adjusted by adjusting an amount of the liquid containing the buffer solution. Examples of the buffer solution include, but are not limited to, various buffer solutions such as a phosphate buffer solution, a glycine buffer solution, a Good's buffer solution, a tris buffer solution, and an ammonia buffer solution.

The water-containing liquid may contain various additives such as an antifoaming agent, a pH adjuster, a viscosity modifier, a rust inhibitor, a preservative, an antifungal agent, an antioxidant, and a reduction inhibitor in addition to the above components as necessary.

### [Hydrogen Generation System]

A hydrogen generation system 100 of the present embodiment will be described with reference to FIG. 1. FIG. 1 is a block diagram schematically illustrating a schematic configuration of the hydrogen generation system 100 of the present embodiment. The hydrogen generation system 100 includes a hydrogen carrier storage container 1, a hydrogen generation apparatus 32, a water supply unit 33, and a fuel cell system 35.

The hydrogen carrier storage container 1 is a container capable of storing a hydrogen carrier (sodium borohydride in the present embodiment), and is a container attachable to and detachable from the hydrogen generation apparatus 32. The charged hydrogen carrier is sent to a hydrogen generation unit of the hydrogen generation apparatus 32 by its own weight, and the amount of the hydrogen carrier to be supplied can be adjusted by an on-off valve attached to the hydrogen generation unit.

The storage container 1 also includes a relief valve 11 for releasing hydrogen gas generated inside to the outside, and a filter 13. The filter 13 is provided between the relief valve 11 and the inside of the storage container 1. The hydrogen gas can pass through the filter 13, but the hydrogen carrier in the container cannot pass through the filter 13. A detailed description of the storage container 1 is provided below.

The water supply unit 33 has a function of supplying a “water-containing liquid” from a tap, a water tank, or the like to the hydrogen generation apparatus 32, and a filter or the like is installed in a flow path in order to remove foreign matters and the like. In addition, for the purpose of promoting or stabilizing the hydrolysis reaction, the water supply unit 33 may have a function of adjusting a temperature of the water-containing liquid to be supplied, such as a heater or a chiller.

The hydrogen generation apparatus 32 includes the hydrogen generation unit, the hydrogen carrier is supplied from the storage container 1 to the hydrogen generation unit, and the water-containing liquid is supplied from the water supply unit 33 to the hydrogen generation unit. The hydrogen generation unit mixes the hydrogen carrier with the water-containing liquid to cause a hydrolysis reaction to generate hydrogen and a byproduct.

The hydrogen generated by the hydrogen generation apparatus 32 is sent to the fuel cell system 35. The fuel cell system 35 generates electricity by using the hydrogen generated by the hydrogen generation apparatus 32, and exemplifies an apparatus that uses the hydrogen generated by the hydrogen generation apparatus 32. The byproduct (sodium metaborate in the present embodiment) generated at the time of hydrogen generation is collected in a collection container (not illustrated).

In such a hydrogen generation system 100, first, after the hydrogen carrier is injected into the storage container 1, the hydrogen carrier is delivered to the hydrogen generation apparatus 32 as it is in a case where hydrogen is not generated or in a case where the amount of the generated hydrogen does not exceed a threshold set in consideration of safety. Then, the hydrogen carrier is supplied from the storage container 1 to the hydrogen generation apparatus 32, the water-containing liquid is supplied from the water supply unit 33 to the hydrogen generation apparatus 32, and the hydrogen gas and the byproduct are generated in the hydrogen generation apparatus 32.

In a case where the hydrogen carrier reacts inside the storage container 1 for some reason to generate the hydrogen gas and the pressure in the storage container 1 thereby exceeds a predetermined value, the relief valve 11 is automatically opened to release extra hydrogen from the inside of the storage container 1 to the outside.

### [Hydrogen Carrier Storage Container]

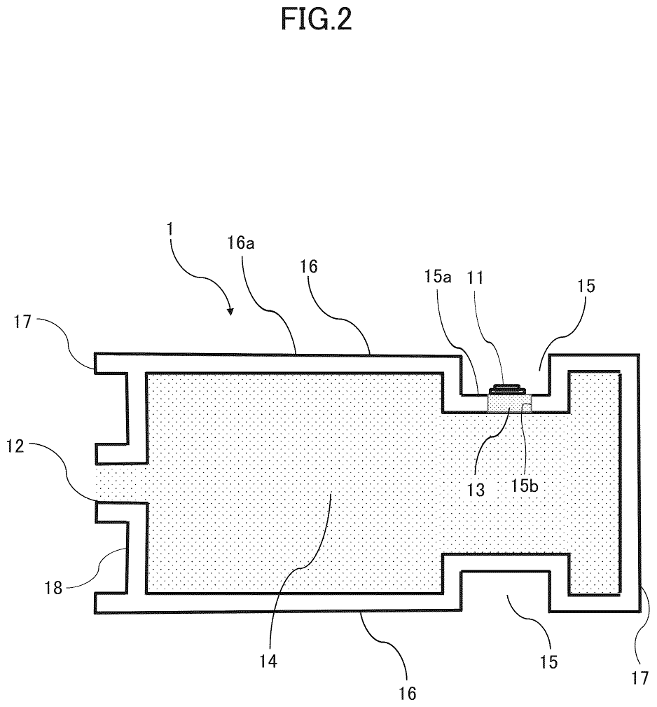

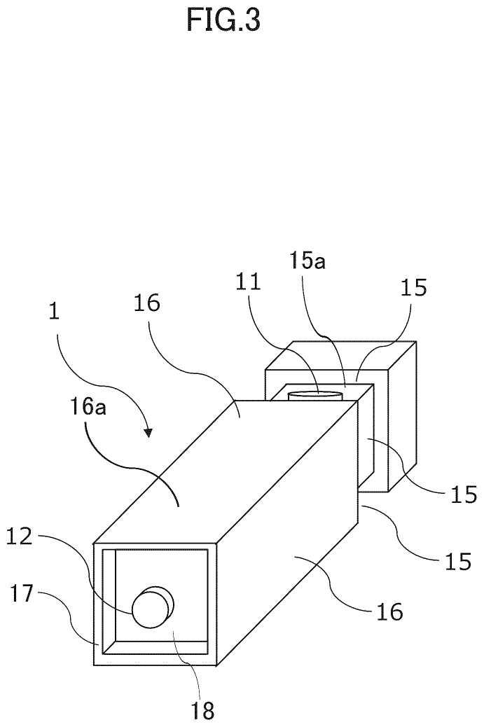

Next, the hydrogen carrier storage container 1 will be described with reference to FIGS. 2 and 3. The storage container 1 includes a storage portion 14 for storing the hydrogen carrier, and has a cylindrical shape whose cross-sectional shape orthogonal to a longitudinal direction is a polygonal shape. In the present embodiment, as illustrated in FIG. 3, the storage container 1 has a prismatic shape whose cross-sectional shape orthogonal to the longitudinal direction is a quadrangular shape. Note that the cross-sectional shape of the storage container 1 that is orthogonal to the longitudinal direction may be other shapes such as a pentagonal shape, a hexagonal shape, and an octagonal shape in addition to the quadrangular shape.

As described below, the storage container 1 includes a flat portion 16 provided on at least a part of an outer wall surface, and it is sufficient if a plurality of storage containers 1 are arranged in a space-saving manner when stacked in a vertical direction or arranged closely in a horizontal direction by making the flat portions 16 (flat portions) of adjacent storage containers 1 face each other and abut on each other or be positioned close to each other. The storage container 1 preferably has a prismatic shape capable of being efficiently stacked in an up-down direction, a front-rear direction, and a left-right direction, and the shape of the storage container 1 may be a pentagonal prism, a hexagonal prism, or an octagonal prism as long as the storage containers 1 can be efficiently stacked in the up-down direction, the front-rear direction, and the left-right direction.

In addition, the storage container 1 is preferably a container made of metal or resin with electrostatic protection from the viewpoint of preventing static electricity. As a result, even if the hydrogen gas is generated inside the storage container 1, it is possible to prevent ignition by static electricity. In addition, as a measure against moisture in the storage container 1, a desiccant or the like may be attached to an inner wall of the container without any particular problem. This makes it possible to suppress the reaction between the hydrogen carrier and water inside the storage container 1 and to suppress the generation of the hydrogen gas.

Such a storage container 1 includes the flat portion 16 serving as a first flat portion, a flat portion 17 serving as a second flat portion, a recess 15 serving as a first recess, the relief valve 11, the filter 13, an opening portion 12, and a recess 18 serving as a second recess. The flat portions 16 are provided on both sides of the outer wall surface of the storage container 1, respectively, in at least one of the up-down direction, the left-right direction, and the front-rear direction in an installed state of the storage container 1. As the flat portions 16 are disposed in this manner, the storage containers 1 can be arranged such that the flat portions 16 abut on each other or are positioned close to each other.

The pair of flat portions 16 is preferably provided on the outer wall surface of the storage container 1 in at least two directions among the up-down direction, the left-right direction, and the front-rear direction, respectively, in the installed state of the storage container 1. As the flat portions 16 are disposed in this manner, the storage containers 1 can be arranged such that the flat portions 16 abut on each other or are positioned close to each other in a plurality of directions. In the present embodiment, since the storage container 1 has a prismatic shape whose cross-sectional shape orthogonal to the longitudinal direction is the quadrangular shape, the pair of flat portions 16 is provided in each of the up-down direction and the left-right direction in the installed state. In the present embodiment, the longitudinal direction of the storage container 1 is defined as the front-rear direction.

As described above, the pair of flat portions 16 is provided in each of the up-down direction and the left-right direction in the installed state, so that the storage containers 1 can be stacked in the up-down direction such that the flat portions 16 abut on each other or are positioned close to each other, and the storage containers 1 can be arranged side by side such that the flat portions 16 abut on each other or are positioned close to each other also in the left-right direction. In addition, even in a case where an orientation of the storage container 1 is changed such that the up-down direction becomes the left-right direction and the left-right direction becomes the up-down direction, similarly, the storage containers 1 can be stacked in the up-down direction, and the storage containers 1 can also be arranged side by side in the left-right direction. The same applies to a relationship between the up-down direction and the front-rear direction and a relationship between the left-right direction and the front-rear direction.

In addition, in the storage container 1 of the present embodiment, the flat portions 17 are provided on both sides in the front-rear direction, respectively. That is, both end portions of the storage container 1 in the longitudinal direction are also defined as the flat portions 17. In other words, the flat portion 17 is provided at a position different from the flat portion 16 on the outer wall surface of the storage container 1, and in the present embodiment, both sides of the storage container 1 in the front-rear direction are defined as the flat portions 17. Then, the storage containers 1 can be arranged side by side such that the flat portions 17 abut on each other or are positioned close to each other in the front-rear direction.

The opening portion 12 is formed in one of the flat portions 17 on both sides in the front-rear direction. The opening portion 12 communicates between the inside and the outside of the storage portion 14, and is provided for injecting the hydrogen carrier into the storage portion 14 or discharging the hydrogen carrier from the storage portion 14. A portion of the flat portion 17 is provided with the recess 18 formed so as to be recessed inward with respect to the other portion. The opening portion 12 is provided in the recess 18.

The opening portion 12 is formed so as to be accommodated in the recess 18. In addition, the opening portion 12 can be connected to a hydrogen carrier supply port of the hydrogen generation apparatus 32 without any gap, and the hydrogen carrier charged in the storage portion 14 can be supplied to the hydrogen generation unit of the hydrogen generation apparatus 32 without leakage. In addition, the opening portion 12 has a structure capable of being connected to an injection port of an injection apparatus (not illustrated) for injecting the hydrogen carrier into the storage container 1 without any gap.

For example, the opening portion 12 is closed by a lid (not illustrated) after the hydrogen carrier is stored in the storage container 1. The recess 18 has such a depth that the lid does not protrude from the recess 18 even in a state in which the opening portion 12 is closed with the lid. Therefore, even in a case where the plurality of storage containers 1 are arranged side by side in the front-rear direction such that the flat portion 17 in which the recess 18 is formed and the flat portion 17 in which the recess 18 is not formed abut on each other or are positioned close to each other, the opening portion 12 and the lid closing the opening portion 12 do not interfere with the facing flat portion 17.

The recess 15 is formed at a portion of at least one of the pair of flat portions 16. The recess 15 is formed so as to be recessed inward with respect to the other portion 16a of the flat portion 16 and to at least partially communicate with the outside of the flat portion 16 in a direction along the flat portion 16. In the present embodiment, as illustrated in FIG. 3, the recess 15 is formed so as to be recessed over the entire circumference at the same position in the longitudinal direction of the storage container 1. That is, the recess 15 is formed in each of the pair of flat portions 16 in the up-down direction in the installed state of the storage container 1, and the recess 15 is also formed in each of the pair of flat portions 16 in the left-right direction. Such four recesses 15 are continuous over the entire circumference of the storage container 1.

Note that it is sufficient if the recess 15 is formed in at least one flat portion 16 among the plurality of flat portions 16. For example, it is sufficient if the right side or the left side of the recess 15, or the front side or the rear side of the recess 15 may communicate with the outside in a case where the recess 15 is formed in the upper flat portion 16 in the installed state. However, it is preferable that the recess 15 communicates with the outside on both sides in the left-right direction or both sides in the front-rear direction. The recess 15 partially communicating with the outside means that a part of the recess 15 is opened and gas can pass between the inside and the outside of the recess 15 even if a side facing a bottom surface of the recess 15 is blocked. For example, in a case where the recess 15 is formed on an upper side of the storage container 1 and a side of the recess 15 in the left-right direction communicates with the outside, even if an upper side of the recess 15 is closed, gas can flow between the inside and the outside of the recess 15 in the left-right direction.

The recess 15 is preferably formed in each of at least two flat portions 16 among the plurality of flat portions 16. For example, the recess 15 may be formed in each of the pair of flat portions 16 described above. Alternatively, in a case where the pair of flat portions 16 is provided on the outer wall surface of the storage container 1 in at least two of the up-down direction, the left-right direction, and the front-rear direction, respectively, in the installed state of the storage container 1, the recess 15 may be formed in each of at least two of the flat portions 16. For example, the recess 15 may be formed in each of the upper flat portion 16 and the right or left flat portion 16.

However, as described below, in order to efficiently discharge the hydrogen gas discharged from the relief valve 11 to the outside, it is preferable that the recess 15 is formed in each of the pair of flat portions 16 on both sides in the up-down direction and the pair of flat portions 16 on both sides in the left-right direction. As a result, regardless of how the storage containers 1 are arranged, a space formed by the recesses 15 facing each other between the adjacent storage containers 1 can communicate with the outside of a region where the storage containers 1 are arranged.

The relief valve 11 is a valve that is provided inside the recess 15 (inside the recess) and is automatically opened in a case where the pressure inside the storage portion 14 exceeds a predetermined value to release the gas inside the storage portion 14 to the outside. The relief valve 11 may be provided in at least one recess 15 among the plurality of recesses 15. As illustrated in FIG. 2, the relief valve 11 is formed on a bottom surface 15a of the recess 15 so as to close a communication port 15b communicating with the storage portion 14. That is, the relief valve 11 is provided on the bottom surface 15a of the recess 15.

The recess 15 has such a depth that the relief valve 11 installed in the recess 15 does not protrude to the outside of recess 15. Therefore, even in a case where the storage containers 1 are stacked in the up-down direction or arranged in the left-right direction or the front-rear direction such that the flat portions 16 in which the recesses 15 are formed abut on each other or are positioned close to each other, the relief valve 11 does not interfere with a part of the adjacent storage containers 1. In addition, an opening/closing operation of the relief valve 11 is not hindered.

As described above, there is a possibility that the hydrogen carrier in the storage container 1 reacts with the water-containing liquid for some reason to generate the hydrogen gas. Then, the hydrogen gas is charged in the storage portion 14, and there is a possibility that the storage container 1 cannot withstand a pressure of the expanded hydrogen gas and ruptures. In such a case, the relief valve 11 is automatically opened by a pressure, and the excessive hydrogen gas is released to the outside, so that damage to the storage container 1 can be avoided.

In addition, the above-described filter 13 is provided in the communication port 15b between the relief valve 11 and the storage portion 14. The filter 13 is configured such that the hydrogen gas can pass through the filter 13 but the hydrogen carrier in the storage portion 14 cannot pass through the filter 13. Therefore, it is possible to prevent the hydrogen carrier from leaking to the outside through the communication port 15b during transportation of the storage container 1 or the like, and it is possible to discharge a part of the hydrogen gas to the outside through the filter 13 and the relief valve 11 provided in the communication port 15b in a case where the pressure of the hydrogen gas in the storage portion 14 increases.

It is sufficient if the relief valve 11 is installed in at least one of the recesses 15 formed on surfaces in four directions orthogonal to the longitudinal direction of the storage container 1, and a plurality of relief valves 11 may be provided in the recesses 15 on other surfaces. Furthermore, the recess may be formed in any one or both of the flat portions 17 on both sides of the storage container 1 in the front-rear direction, and the relief valve 11 may be provided in the recess. For example, the relief valve 11 may be provided in the recess 18 in which the opening portion 12 is formed.

In the present embodiment, one relief valve 11 is provided in one recess 15, but the relief valve 11 is preferably provided in each of two or more recesses 15. For example, in a case where the recess 15 is formed in each of the pair of flat portions 16 on both sides in the up-down direction or the left-right direction in the installed state, the relief valve 11 may be provided in each of the plurality of recesses 15.

Alternatively, in a case where the pair of flat portions 16 is provided on the outer wall surface of the storage container 1 in at least two of the up-down direction, the left-right direction, and the front-rear direction, respectively, in the installed state of the storage container 1, and the recess 15 is formed in each of at least two flat portions 16 among the plurality of flat portions 16, the relief valve 11 is preferably provided in each of the plurality of recesses 15. That is, the relief valve 11 may be provided in each of the recesses 15 formed in the pair of flat portions 16 on both sides in any one of the up-down direction, the left-right direction, and the front-rear direction, or may be provided in each of the recesses 15 formed in the plurality of flat portions 16 regardless of the direction. For example, one relief valve 11 may be provided on the upper side in the installed state, and one relief valve 11 may be provided on the right side or the left side.

Further, in a case where the pair of flat portions 16 is provided on the outer wall surface of the storage container 1 in each of the up-down direction and the left-right direction in the installed state of the storage container 1, and the recess 15 is formed in each of all the flat portions 16, the relief valve 11 is preferably provided in each of all the recesses 15. In this case, the relief valve 11 is provided in all the recesses 15 on the upper side, the lower side, the right side, and the left side in the installed state.

At least one relief valve 11 is sufficient since the relief valve 11 is automatically opened in a case where the pressure inside the storage container 1 exceeds a predetermined value, but it is preferable to provide the relief valve 11 in each of the recesses 15 of the plurality of flat portions 16 as described above from the viewpoint of more reliably discharging the hydrogen gas through the relief valve 11. For example, in a case where the relief valve 11 is positioned on the lower side in the installed state, since a specific gravity of the hydrogen gas is smaller than that of air, there is a possibility that the hydrogen gas is hardly discharged from the relief valve 11 on the lower side. In this case, if there are other relief valves 11 on the upper side, the right side, the left side, and the like in the installed state, the hydrogen gas can be efficiently discharged through the relief valves 11.

The relief valve 11 is preferably positioned on the upper side in the installed state of the storage container 1 from the viewpoint of efficiently discharging the hydrogen gas. Therefore, as described above, by providing the relief valve 11 on any of the upper side, the lower side, the right side, and the left side, it is possible to position any relief valve 11 on the upper side without considering the orientation of the storage container 1 in the case of installing the storage container 1.

### [Storage of Storage Container]

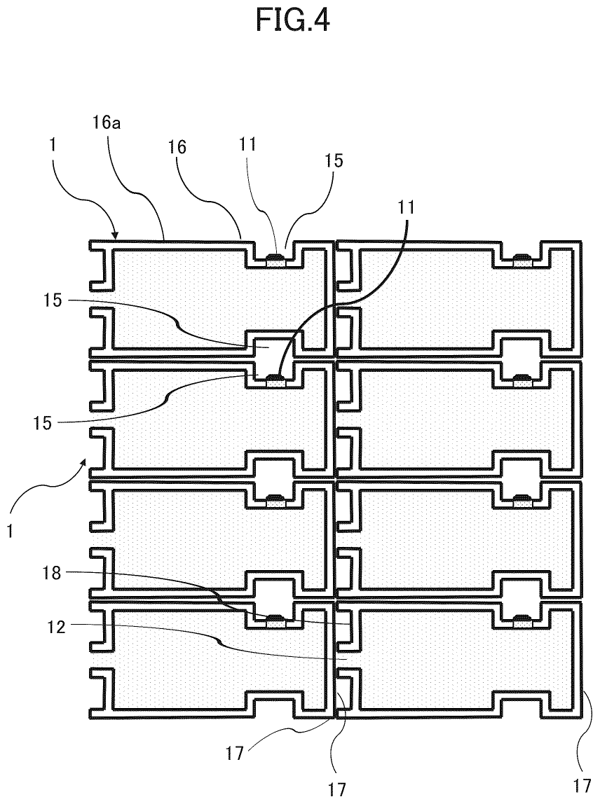

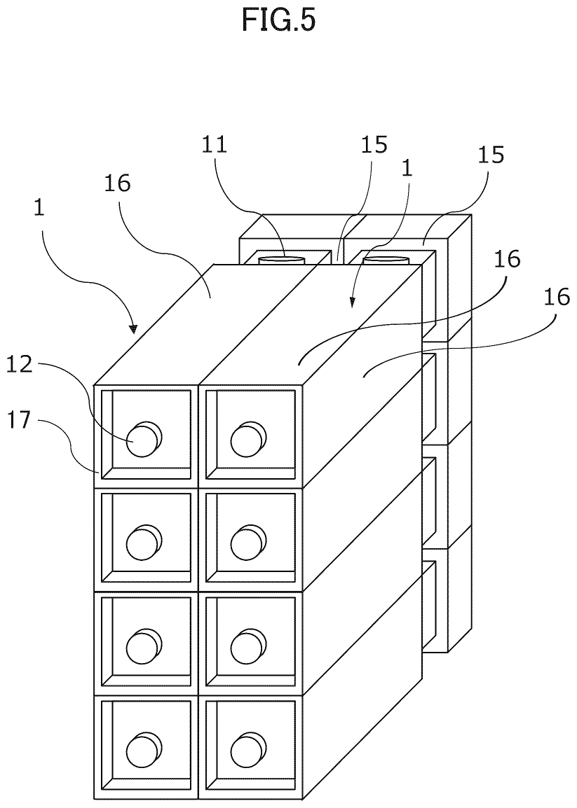

A storage state of the storage container 1 will be described with reference to FIGS. 4 and 5. FIGS. 4 and 5 illustrate an example of a storage state in which a plurality of storage containers 1 are arranged side by side. In the storage container 1 illustrated in FIGS. 4 and 5, the recesses 15 are formed so as to be continuous in four directions of the up-down direction and the left-right direction in the installed state and over the entire circumference. The relief valve 11 is provided in the upper recess 15 in the installed state.

FIG. 4 illustrates a case where the plurality of storage containers 1 overlap each other in the up-down direction and are arranged side by side in the front-rear direction. In the front-rear direction of the storage container 1, since the opening portion 12 is formed so as to be accommodated in the recess 18, the storage containers 1 can be arranged without a gap in the front-rear direction such that the flat portions 17 of the storage containers 1 arranged in the front-rear direction abut on each other.

On the other hand, in the up-down direction of the storage container 1, the plurality of storage containers 1 can be stacked vertically without a gap such that the upper flat portion 16 of the lower storage container 1 abuts on the lower flat portion 16 of the upper storage container 1. At this time, the recess 15 formed in the upper flat portion 16 of the lower storage container 1 and the recess 15 formed in the lower flat portion 16 of the upper storage container 1 face each other, and a space penetrating in the left-right direction is formed between both the recesses 15. The relief valve 11 is provided in the recess 15 of the lower storage container 1, and the hydrogen gas discharged from the relief valve 11 is discharged to the outside of a region where the plurality of storage containers 1 are stacked through the space.

FIG. 5 illustrates a case where the plurality of storage containers 1 are stacked in the up-down direction and are arranged side by side in the left-right direction. A relationship between the respective parts in a case where the storage containers 1 are stacked in the up-down direction is as described in FIG. 4. On the other hand, in the left-right direction of the storage container 1, the plurality of storage containers 1 can be horizontally arranged without any gap such that the left flat portion 16 of the right storage container 1 and the right flat portion 16 of the left storage container 1 abut on each other. At this time, the recess 15 formed in the left flat portion 16 of the right storage container 1 and the recess 15 formed in the right flat portion 16 of the left storage container 1 face each other, and a space penetrating in the up-down direction is formed between both the recesses 15. Therefore, the hydrogen gas discharged from the relief valve 11 of the lower storage container 1 is discharged to the outside of a region where the plurality of storage containers 1 are stacked and arranged closely in the left-right direction through the space in the left-right direction formed between the pair of vertically facing recesses 15 and the space in the up-down direction formed between the pair of horizontally facing recesses 15.

As described above, in the present embodiment, the recess 15 is formed in each of the flat portions 16 that abut on each other or are positioned close to each other in a case where the plurality of storage containers 1 are stacked or arranged side by side, and the relief valve 11 is provided in the recess 15. The recess 15 is formed so as to at least partially communicate with the outside of the flat portion 16 in a direction along the flat portion 16. Therefore, the hydrogen gas discharged from the relief valve 11 is easily discharged to the outside from a portion of the recess 15, which communicates with the outside. Therefore, it is possible to suppress an increase in pressure in the storage container 1 even in a case where the storage containers 1 are stored so as to be stacked in the up-down direction or arranged closely in the left-right direction or the front-rear direction. In addition, it is possible to prevent the hydrogen gas discharged from the relief valve 11 from staying between the plurality of storage containers 1 and to improve a safety of a storage place.

### Another Example of First Embodiment

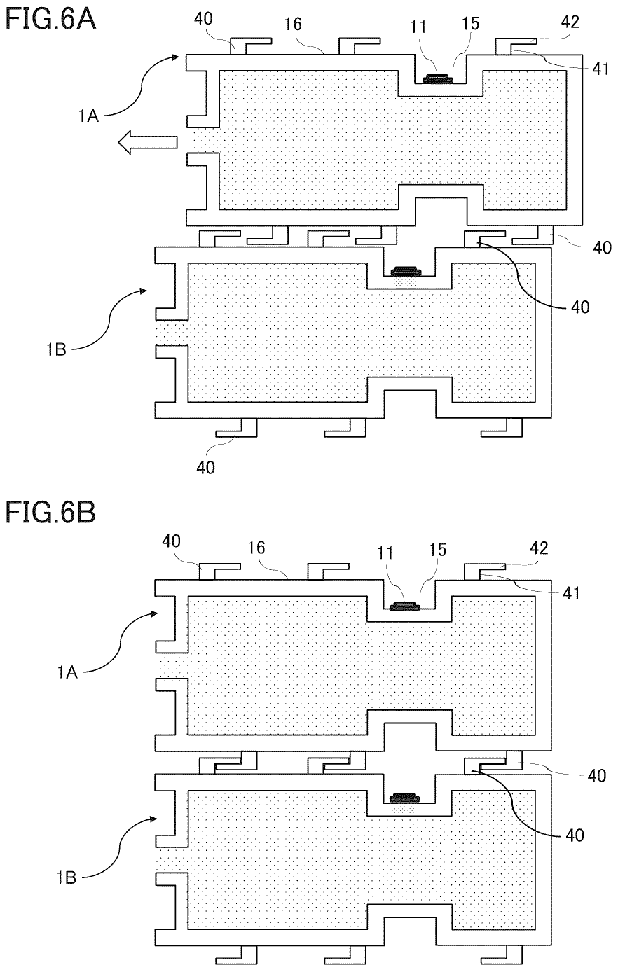

Another example of the first embodiment will be described with reference to FIGS. 6A and 6B. In the above example, a configuration in which the plurality of storage containers 1 are simply stacked or arranged side by side has been described. On the other hand, in the present example, a fitting portion 40 for fitting a plurality of storage containers 1A and 1B that are stacked or arranged side by side is provided. The fitting portion 40 is provided on the flat portion 16, and the fitting portion 40 provided in the storage container 1A can be fitted to the fitting portion 40 provided in the other storage container 1B in a state in which the storage container 1A is installed such that the flat portion 16 faces that of the other storage container 1B.

In the present embodiment, the fitting portion 40 includes a protruding portion 41 protruding from the flat portion 16 and a bent portion 42 bent from the protruding portion 41 in a direction substantially parallel to the flat portion 16. Such a fitting portion 40 may be provided on each of the flat portions 16 on both sides in the up-down direction in the installed state, may be provided on each of the flat portions 16 on both sides in the left-right direction, or may be provided on each of all the flat portions 16 in the up-down direction and the left-right direction. In the front-rear direction, the fitting portion 40 may be provided on the flat portion 17 by, for example, reducing a size of the recess 18 on a side where the opening portion 12 is formed or providing the opening portion 12 on another surface. In the present example, a plurality of (three in the illustrated example) fitting portions 40 are provided on each of all the flat portions 16 in the up-down direction and the left-right direction.

In a case where the storage containers 1A and 1B are stacked, the fitting portions 40 are arranged so as to be shifted from each other in the front-rear direction as illustrated in FIG. 6A. Then, the fitting portions 40 are fitted to each other by shifting one of the storage containers 1A and 1B in the front-rear direction with respect to the other as illustrated in FIG. 6B. At this time, since the bent portions 42 vertically overlap each other, it is possible to suppress separation of the storage containers 1A and 1B in the up-down direction. In addition, since a tip of one bent portion 42 and the other protruding portion 41 face each other, it is possible to suppress displacement of the storage containers 1A and 1B in the front-rear direction.

The same applies to a case where the storage containers 1A and 1B are arranged side by side in the left-right direction, and since the bent portions 42 of the storage containers 1A and 1B overlap each other in the left-right direction, it is possible to suppress separation of the storage containers 1A and 1B in the left-right direction.

By providing the fitting portion 40 in this manner, the storage containers 1A and 1B can be fixed to each other. As a result, in a case where the storage containers 1A and 1B are carried or stored in a state of being stacked or arranged side by side, it is possible to prevent the occurrence of load shifting due to vibration or inadvertent displacement due to an external force.

### Second Embodiment

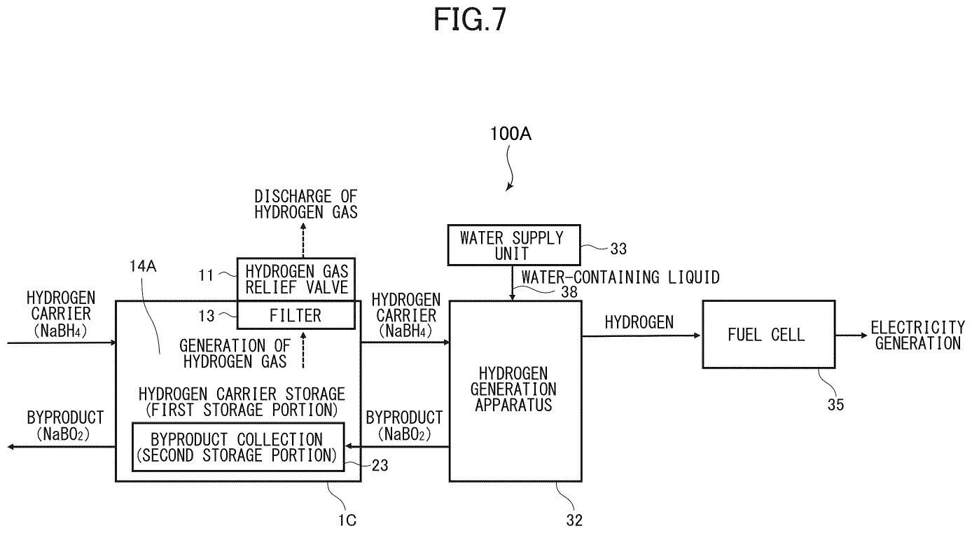

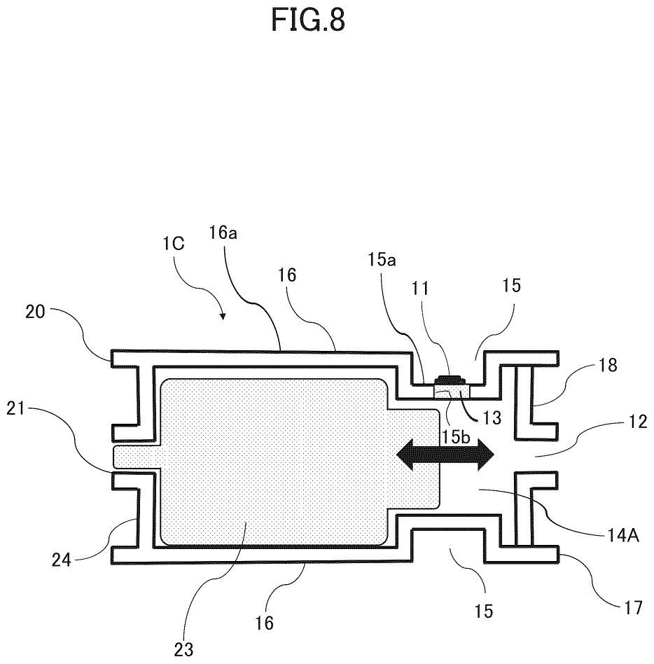

A second embodiment will be described with reference to FIGS. 7 and 8. The storage container 1 that stores the hydrogen carrier has been described in the first embodiment described above. On the other hand, in the present embodiment, a byproduct can also be stored in a storage container 1C. Other configurations and operations are the same as those of the first embodiment described above, and thus, the same reference numerals are given to the same configurations to omit or simplify the description, and hereinafter, differences from the first embodiment will be mainly described.

The present embodiment is an example in which the storage container is not only used for delivery and supply of a raw material (hydrogen carrier) to a hydrogen generation apparatus 32, but also used as a collection container for the byproduct after a hydrogen generation reaction (the byproduct in a case where the hydrogen carrier is sodium borohydride is sodium metaborate).

FIG. 7 is a block diagram schematically illustrating a schematic configuration of a hydrogen generation system 100A of the present embodiment. The hydrogen generation system 100A includes the storage container 1C for the hydrogen carrier and the byproduct, the hydrogen generation apparatus 32, a water supply unit 33, and a fuel cell system 35. A configuration other than the storage container 1C is the same as the configuration illustrated in FIG. 1. In the hydrogen generation system 100A of the present embodiment, similarly to the configuration of FIG. 1, first, after the hydrogen carrier is injected into the storage container 1C, the hydrogen carrier is delivered to the hydrogen generation apparatus 32 as it is in a case where hydrogen is not generated or in a case where the amount of the generated hydrogen does not exceed a threshold set in consideration of safety. Then, the hydrogen carrier is supplied from the storage container 1C to the hydrogen generation apparatus 32, a water-containing liquid is supplied from the water supply unit 33 to the hydrogen generation apparatus 32, and hydrogen gas and the byproduct are generated in the hydrogen generation apparatus 32.

In a case where a hydrogen generation reaction in the hydrogen generation apparatus 32 ends and the storage container 1C is used as a collection container for the byproduct, in a case where hydrogen is not generated from the collected byproduct, or in a case where the amount of the generated hydrogen does not exceed the threshold set in consideration of safety, the byproduct is collected in the storage container 1C as it is. In a case where hydrogen is generated from the byproduct for some reason and an air pressure in the storage container 1C thereby exceeds a predetermined value, a hydrogen gas relief valve 11 is automatically opened to release extra hydrogen to the outside of the container.

Such a configuration of the storage container 1C will be described with reference to FIG. 8. The storage container 1C includes a first storage portion 14A and a second storage portion 23. The first storage portion 14A is a portion that stores the hydrogen carrier, and the second storage portion 23 is a portion that stores the byproduct generated together with hydrogen in a case where the hydrogen carrier reacts with the water-containing liquid. The second storage portion 23 does not allow the byproduct to pass into the first storage portion 14A, but allows gas generated in the second storage portion 23 to pass into the first storage portion 14A. In the present embodiment, the second storage portion 23 has a stretchable bag shape and is disposed inside the first storage portion 14A. A material of the second storage portion 23 may be fiber or rubber.

As in the first embodiment described above, the storage container 1C includes a flat portion 16, a recess 15, the relief valve 11, and the like. In addition, a recess 18 is formed in a flat portion 17 on one side in the front-rear direction, and an opening portion 12 for injecting the hydrogen carrier into the first storage portion 14A or discharging the hydrogen carrier from the first storage portion 14A is formed. Meanwhile, a flat portion 20 serving as a third flat portion is provided on the other side in the front-rear direction. The flat portion 20 is provided at a position different from the flat portion 16 serving as a first flat portion in an outer wall surface of the storage container 1C, and in the present embodiment, is provided on a surface on a side opposite to a side where the opening portion 12 is formed. The flat portion 20 abuts on or is positioned close to the flat portion 17 in a case where the storage containers 1C are arranged side by side in the front-rear direction.

A recess 24 serving as a third recess is formed at a portion of the flat portion 20 so as to be recessed inward with respect to the other portion. In the recess 24, an opening portion 21 is formed as a byproduct opening portion for communicating between the inside and the outside of the second storage portion 23 and injecting the byproduct into the second storage portion 23 or discharging the byproduct from the second storage portion 23. The opening portion 21 is formed so as to be accommodated in the recess 24. The opening portion 21 can be connected to a byproduct discharge port of the hydrogen generation apparatus 32 without any gap, and the byproduct can be collected from the hydrogen generation apparatus 32 without leakage. In addition, the opening portion 21 has a structure capable of being connected to a collection port of a collection apparatus (not illustrated) for collecting the byproduct in the second storage portion 23 without any gap.

The stretchable bag-shaped second storage portion 23 is connected to the opening portion 21, and the byproduct collected through the opening portion 21 is sent to the second storage portion 23. The second storage portion 23 expands due to its stretchability according to a volume of the collected byproduct. In a case where the byproduct in the second storage portion 23 is collected by the collection apparatus (not illustrated), the second storage portion 23 is contracted due to its stretchability.

The byproduct collected in the second storage portion 23 is a byproduct after the reaction in the hydrogen generation apparatus 32, and may contain moisture or contain unreacted residual hydrogen carriers. Therefore, there is a possibility that residual hydrogen gas is generated in the second storage portion 23. For this reason, the second storage portion 23 has a stretchable bag shape, and has a specification in which only the hydrogen gas is allowed to pass even in a case where the hydrogen gas is generated from the byproduct, and the byproduct itself remains impermeable. Then, the hydrogen gas that has passed into the first storage portion 14A from the second storage portion 23 is discharged to the outside from the relief valve 11.

In such a case of the present embodiment, even in a case where the storage container 1C is used for storing the byproduct, the hydrogen gas generated inside the storage container 1C can be discharged from the relief valve 11. In addition, as in the first embodiment, it is possible to suppress an increase in pressure in the storage container 1C even in a case where the storage containers 1C are stored so as to be stacked in the up-down direction or arranged closely in the left-right direction or the front-rear direction. In addition, it is possible to prevent the hydrogen gas discharged from the relief valve 11 from staying between the plurality of storage containers 1C and to improve a safety of a storage place. The storage container 1C of the present embodiment may also be provided with the fitting portion 40 described in FIGS. 6A and 6B.

### Other Embodiments

In the first embodiment described above, the hydrogen carrier storage container 1 has been described. However, the byproduct may be stored in the storage container 1. That is, the hydrogen carrier storage container 1 may be used as the byproduct storage container. In this case, the storage portion 14 of the storage container 1 stores the byproduct.

According to the present disclosure, it is possible to suppress an increase in pressure in the storage container even in a case where the storage containers for storing the hydrogen carrier and the byproduct are stored so as to be stacked in the up-down direction or arranged closely in the left-right direction or the front-rear direction.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A hydrogen carrier storage container configured to store a hydrogen carrier, the hydrogen carrier storage container comprising:
a storage portion storing the hydrogen carrier;
a pair of flat portions provided on both sides of an outer wall surface of the storage container, respectively, in at least one of an up-down direction, a left-right direction, and a front-rear direction in an installed state of the storage container;
a recess formed at a portion of at least one of the pair of flat portions and formed so as to be recessed inward with respect to another portion of the flat portion and to at least partially communicate with an outside of the flat portion in a direction along the flat portion; and
a relief valve provided in the recess and automatically opened in a case where a pressure inside the storage portion exceeds a predetermined value to release gas inside the storage portion to an outside.

2. The hydrogen carrier storage container according to claim 1, wherein the recess is formed in each of the pair of flat portions.

3. The hydrogen carrier storage container according to claim 1, wherein
the pair of flat portions is provided on the outer wall surface of the storage container in at least two of the up-down direction, the left-right direction, and the front-rear direction in the installed state of the storage container, and
the recess is formed in each of at least two of a plurality of the flat portions.

4. The hydrogen carrier storage container according to claim 2, wherein the relief valve is provided in each of a plurality of the recesses.

5. The hydrogen carrier storage container according to claim 1, wherein
the pair of flat portions is provided on the outer wall surface of the storage container in each of the up-down direction and the left-right direction in the installed state of the storage container, and
the recess is formed in each of all the flat portions.

6. The hydrogen carrier storage container according to claim 5, wherein the relief valve is provided in each of all the recesses.

7. The hydrogen carrier storage container according to claim 1, further comprising an opening portion communicating between an inside and an outside of the storage portion, the opening portion through which the hydrogen carrier is injected into the storage portion or discharged from the storage portion.

8. The hydrogen carrier storage container according to claim 7, wherein
the recess is a first recess,
the flat portion in which the first recess is formed is a first flat portion,
the hydrogen carrier storage container comprises
a second flat portion provided at a position different from the first flat portion on the outer wall surface of the storage container, and
a second recess formed at a portion of the second flat portion so as to be recessed inward with respect to another portion,
wherein the opening portion is provided in the second recess.

9. The hydrogen carrier storage container according to claim 1, further comprising a fitting portion provided on the flat portion and configured to be fitted to the fitting portion provided in another storage container in a state in which the storage container is installed such that the flat portion of the storage container and the flat portion of the another storage container face each other.

10. The hydrogen carrier storage container according to claim 9, wherein the fitting portion includes a protruding portion protruding from the flat portion, and a bent portion bent from the protruding portion in a direction substantially parallel to the flat portion.

11. The hydrogen carrier storage container according to claim 1, wherein the storage container has a cylindrical shape whose cross-sectional shape orthogonal to a longitudinal direction is a polygonal shape.

12. The hydrogen carrier storage container according to claim 1, wherein
the storage portion is a first storage portion,
the hydrogen carrier storage container further comprises a second storage portion storing a byproduct generated together with hydrogen in a case where the hydrogen carrier reacts with a water-containing liquid,
wherein the second storage portion does not allow the byproduct to pass into the first storage portion, but allows gas generated in the second storage portion to pass into the first storage portion.

13. The hydrogen carrier storage container according to claim 12, wherein
the recess is a first recess,
the flat portion in which the first recess is formed is a first flat portion,
the hydrogen carrier storage container comprises
a third flat portion provided at a position different from the first flat portion on the outer wall surface of the storage container,
a third recess formed at a portion of the third flat portion so as to be recessed inward with respect to another portion, and
a byproduct opening portion communicating between an inside and an outside of the second storage portion, and injecting the byproduct into the second storage portion or discharging the byproduct from the second storage portion,
wherein the byproduct opening portion is provided in the third recess.

14. A byproduct storage container configured to store a byproduct generated together with hydrogen in a case where a hydrogen carrier reacts with a water-containing liquid, the byproduct storage container comprising:
a storage portion storing the byproduct;
a pair of flat portions provided on both sides of an outer wall surface of the storage container, respectively, in at least one of an up-down direction, a left-right direction, and a front-rear direction in an installed state of the storage container;
a recess formed at a portion of at least one of the pair of flat portions and formed so as to be recessed inward with respect to another portion of the flat portion and to at least partially communicate with an outside of the flat portion in a direction along the flat portion; and
a relief valve provided in the recess and automatically opened in a case where a pressure inside the storage portion exceeds a predetermined value to release gas inside the storage portion to an outside.
